(19) United States
(12) Patent Application Publication
(10) Pub. No.: US 2026/0128040 A1
(43) Pub. Date: May 7, 2026

(54) SYSTEMS AND METHODS FOR AUTO-LABELING AND NATURAL LANGUAGE PROCESSING

(71) Applicant: JPMORGAN CHASE BANK, N.A., New York, NY (US)

(72) Inventors: Yungkwon KIM, New York, NY (US); Di WU, Rutherford, NJ (US); Donald STEPHENS, Holliswood, NY (US); Lei Carol LIANG, Hamburg, NJ (US)

(21) Appl. No.: 18/936,445

(22) Filed: Nov. 4, 2024

(51) Int. Cl. G10L 15/187; G10L 25/51

(52) U.S. Cl. CPC G10L 15/187; G10L 25/51

(57) ABSTRACT

In some embodiments, the techniques described herein relate to a method including: receiving, by a text or call processing program, a plurality of seed utterances each with a plurality of predefined seed labels; receiving a first user utterance; converting the plurality of seed utterances and the first user utterance into n-gram phrases; grouping n-gram phrases of the plurality of seed utterances into phrase pools based on whether the n-gram phrases are 2-gram phrases or 3-gram phrases; executing n-gram matching of the user utterance with a first seed utterance of the plurality of seed utterances; and assigning a first intent label to the first user utterance based on a match of 3-gram phrases with the first seed utterance of the plurality of seed utterances.

### BACKGROUND

### 1. Field of the Invention

Embodiments generally relate to systems and methods for auto-labeling and natural language processing.

### 2. Description of the Related Art

Companies receive thousands of calls from individuals seeking support, help, and access to a variety of company resources. The handling of those calls requires significant resources in human hours, bandwidth, and management hierarchy. Analysis of incoming calls and their contents can help a company to allocate resources according to customer needs. Appropriate analysis is theoretically based on accurate representation of what occurred during the call. Due to the nature of the analysis, companies develop models based on natural language processing to automated the process. However, to measure how accurate this automated system is not apparent since the data is human-languages, unstructured data that requires manual examination, which will be available on small samples only. Improved systems can drastically increase the coverage of data to be analyzed with much higher efficiency as well, leading to improve accuracy of tracking and analysis, and thus actions based on the tracking and analysis can be improved as a result.

### SUMMARY

In some embodiments, the techniques described herein relate to receiving, by a text or call processing program, a plurality of seed utterances each with a predefined seed label; receiving, by the text or call processing program, a first user utterance; converting, by the text or call processing program, the plurality of seed utterances and the first user utterance into n-gram phrases; grouping n-gram phrases of the plurality of seed utterances into phrase pools based on whether the n-gram phrases are 2-gram phrases or 3-gram phrases; executing, by the text or call processing program, n-gram matching of the first user utterance with a first seed utterance of the plurality of seed utterances; and assigning, by the text or call processing program, a first intent label to the first user utterance based on a match of 3-gram phrases with the first seed utterance of the plurality of seed utterances.

According to some embodiments, the method may further comprise filtering out, by the text or call processing program, non-frequent n-gram phrases in each phrase pool based on a predefined frequency threshold. According to some embodiments, the method may further comprise marking, by the text or call processing program, a second user utterance with only one or more 2-gram matches for further processing. According to some embodiments, the method may further comprise executing, by the text or call processing program, matching of the second user utterance with a second seed utterance of the plurality of seed utterances based on a pseudo-label of the second user utterance and the predefined seed label of the second seed utterance, the matching comprising: determining an output score comprising the 2-gram match and a distance between the second user utterance and the second seed utterance; and determining the output score exceeds a threshold score; and assigning, by the text or call processing program, the pseudo-label as a second intent label to the second user utterance based on the matching.

According to some embodiments, the method may further comprise marking, by the text or call processing program, a third user utterance with no n-gram matches for further processing. According to some embodiments, the method may further comprise executing, by the text or call processing program, matching of the third user utterance with a third seed utterance of the plurality of seed utterances based on a pseudo-label of the third user utterance and the predefined seed label of the third seed utterance, the matching comprising: determining an output score comprising at least two distance measures between the third user utterance and the third seed utterance; and determining the output score exceeds a threshold score; and assigning, by the text or call processing program, the pseudo-label as a third label to the third user utterance based on the matching.

According to some embodiments, the method may further comprise determining, by the text or call processing program, a text response or an audible response based on a search of responses associated with the first intent label; and outputting, by the text or call processing program, the text response or the audible response.

Embodiments consistent with the present disclosure include a system including one or more processors and one or more storage devices storing instructions that when executed by one or more processors, cause the processor to perform one or more steps of the methods disclosed herein. Embodiments consistent with the present disclosure include a computer processing system, computer, or server, including: a memory configured to store instructions such as a non-transitory computer-readable storage medium; and a hardware processor operatively coupled to the memory for executing the instructions to perform one or more steps of the methods disclosed herein.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 illustrates a logical flow for labeling utterances, in accordance with embodiments.

FIG. 2 illustrates a logical flow for labeling utterances, in accordance with embodiments.

FIG. 3 illustrates a logical flow for labeling utterances, in accordance with embodiments.

FIG. 4 illustrates a logical flow for labeling utterances, in accordance with embodiments.

FIG. 5 illustrates a graph of an elbow method used for labeling utterances, in accordance with embodiments.

FIG. 6 illustrates a block diagram of a computing device for implementing certain embodiments of the present disclosure.

### DETAILED DESCRIPTION

Embodiments generally relate to systems and methods for auto-labeling and natural language processing.

Customer calls currently are being handled by human experts handling and responding based on the content of the customer calls. Responding to customer calls is difficult to automate because of diverse embodiments of human language. In other words, different wants and needs are often described by people in very different ways. Additionally, people refer to additional or extraneous details aside from wants and needs. These various ways of expression make it difficult in conventional systems to pinpoint core information, underlying wants and needs. Post-call analysis has been used to try to improve systems, but results so far have been problematic for automated post-call analyses. Call performance analysis has been shown to be inaccurate because of a large amount of noise in the results. In particular, dialogue flow during a call can mislead current systems from divining the true intent of a call. In part, this is because of the large number of ways that ideas are conveyed, even for similar subject matter. Additionally, extraneous phrases or introductory matter can easily mislead current systems.

Call performance analysis can be improved by creating labels for utterances made during customer calls. Embodiments consistent with the disclosure herein increase the efficiency of handling customer calls by predicting call reasons based on utterances. Performance evaluation of customer calls can be improved by generating ground-truth labels for each utterance to compare the prediction against actual results. This can be accomplished through disclosed methods including by recognizing similarity among utterances.

In accordance with embodiments, label generation is conducted by a computer program executed on one or more processors based on utterances during user dialogue. To accomplish accurate label generation, short text matching (STM) methods are utilized by the computer program. For each unlabeled utterance, the proposed methods and systems may select a similar utterance from one or more labeled utterances and assign the label to the unlabeled utterance. Important to this methodology are non-limiting characteristics including that most utterances have a length of three to five tokens, a token being a word, part of a word, or characters like punctuation. The methodology may also be based on a record of key words and phrase, a high frequency of some utterances, and/or a low variance between utterances.

In accordance with embodiments, the method can include stages of model guided N-gram matching, model guided distance matching, and free matching. The method includes using one or more metrics include a coverage rate and an accuracy. The coverage rate can be a percentage of production utterance labeled. The accuracy can be a percentage of labels assigned correctly, judged against manual input, previously known correct labels, and/or a check machine learning program. Each stage is designed to label utterances that were not handled by the previous stage, resulting in later stages having increased coverage but with less accurate labels. This is because the remaining unmatched utterances after each stage have less discriminative features compared to utterances that were matched in the current stage.

In accordance with embodiments, metrics may be normalized by a weighting metric, the weighting metric being applied based on utterance distribution (e.g., based on a count of utterances or a frequency of utterances). Some utterances have higher frequency, and those with higher frequencies can be given more weight than those of less frequency. Thus, normalized coverage rate and normalized accuracy can be used for evaluation. As an example, if there are three unique utterances and the frequencies are (10, 20, 1000) respectively. If the proposed method correctly generates labels for the first two utterances, the accuracy would be ⅔ (66.7%) and the normalized accuracy would be 30/1030 (2.9%).

In accordance with embodiments, utterances may be received by an automated customer call processing machine. The automated customer call processing machine may process utterances by a customer, according to disclosed methods, as the utterances are provided. The automated customer call processing machine may select a menu item, a pre-recorded response, or to generate a response. The selection may be based on the processing of the utterances. The output, through a like or different communication method, may a vocal response based on the selection to the user. The output may require speaking, through a text-to-voice application, to the user.

In accordance with embodiments, utterances may be received by an automated text processing machine. The automated text processing machine may receive text from a user through a chat through a browser or application, a text received through SMS, an email, or a voice-to-text application that processes a call or voicemail. The automated text processing machine may, based on the received text, select a menu item, a pre-recorded response, generate a response, or generate a proposed search selection. The selection may be based on the processing of the utterances. The output, through a like or different communication method, may be a text based on the selection to the user. The output may require sending or displaying the output to the user.

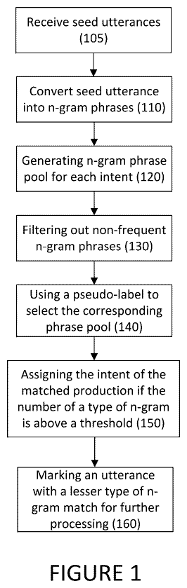

FIG. 1 illustrates a logical flow for labeling utterances, in accordance with embodiments.

The logical flow may comprise one or more steps stored as instructions on a memory that, when executed by a processor, cause the processor to perform the one or more steps.

At step 105, a text or call processing program may receive a number of utterances with labels known to be correct. The number of utterances may be stored on a memory accessible by the text or call processing program. The number of utterances with known labels may be seed utterances. At step 105, a text or call processing program may receive a number of user utterances from an application, a communication method, a browser input, a user interface, a chat, or a voice-to-text application. An elbow method may be applied to identify and select a total number of seed utterances.

At step 110, the text or call processing program may perform n-gram matching of the seed utterances. Step 110 may include converting each seed utterance into n-gram phrases. For example, an utterance such as “check my bank balance” can be converted into a unigram (‘check’, ‘my,’ ‘bank,’ ‘balance’), a 2-gram (‘check my,’ ‘my bank,’ ‘bank balance’), a 3-gram (‘check my bank,’ ‘my bank balance’), and a 4-gram (‘check my bank balance’).

At step 120, the text or call processing program may generate a n-gram phrase pool for each intent of the seed utterances by grouping the n-gram phrases of the seed utterances. For example, step 120 may include a step of converting each user utterance “uᵢ” into a set of 2-gram phrases “S₂ᵢ” and 3-gram phrases “S₃ᵢ.”

At step 130, the text or call processing program may filter out the non-frequent n-gram phrase in each phrase pool based on a predefined frequency threshold. For example, infrequent 2-gram phrases may be filter from the set of 2-gram phrases S₂ᵢ.

At step 140, the text or call processing program may use a pseudo-label of uᵢ to select the corresponding 2-gram and 3-gram phrase pool and check how many 2-grams/3-grams from S₂ᵢ/S₃ᵢ are in the selected phrase pool. The pseudo-label may be a predicted intent of a user utterance. The pseudo-label may be generated by a machine-learning model based on a content of the pseudo-label. In some embodiments, the machine-learning model may produce a confidence score associated with the generated pseudo-label. In some embodiments, the text or call processing program may use the generated pseudo-label if the confidence score exceeds a threshold but use no pseudo-label, a pseudo-label of a 3-gram or a higher n-gram phrase, or a pseudo-label based on a key word or phrase (e.g., “account,” “menu,” “customer service”) if the confidence score is less than a threshold.

At step 150, the text or call processing program may assign an intent of the matched seed production as the label of uᵢ if the number of a type of n-gram (e.g., 3-gram) found matched to the seed utterance is above a predefined threshold. Research has shown that matching 3-grams at this step produces optimal results. Step 160 may include capturing the key word/phrase within n-gram phrases. The importance of the n-gram phrase is determined by the within-intent phrase frequency. The within-intent frequency is the count of occurrences of a given n-gram phrase from its n-gram phrase pools. In some embodiments, because a variance of the utterance is low, n-gram phrase matching plays an important role in determining the intent of an utterance compared to longer and more sophisticated phrases of the utterance.

In some embodiments, the text or call processing program may determine a text response (e.g., for a search bar suggestion, a menu selection item, a chat response, a text response, an email response) or an audible response (e.g., for a menu selection item, a voice message over a phone connection) based on a search of responses associated with the first intent label. In some embodiments, the search may use a machine learning model. The search may include a phrase from the user utterance with the intent as context. In some embodiments, the text or call processing program may output the text response or the audible response such as through displaying the text response on a screen connected to an application in communication with the text or call processing program or outputting an audible response over a phone or internet connection. In some embodiments, a voice-to-text system may be used for outputting an audible response.

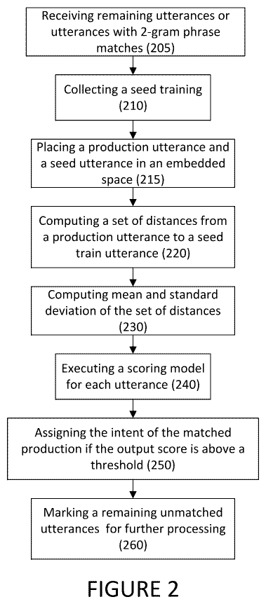

At step 160, the text or call processing program may mark uᵢ as a 2-gram match for processing under the method disclosed with reference to FIG. 2 if the number of 2-grams matched is above a 2-gram predefined threshold but the number of 3-grams matched is below a 3-gram predefined threshold.

At step 160, the text or call processing program may include sending any remaining utterance without a label to a method disclosed with reference to FIG. 2. Step 160 may include sending any 2-gram phrase matches, but no further n-gram matches (e.g., 3-gram phrase matches, 4-gram phrase matches, etc.), to the method disclosed with reference to FIG. 2. In some embodiments, user utterances with 2-gram phrase matches may be weighted greater than utterances with no n-gram phrase matches.

FIG. 2 illustrates a logical flow for labeling utterances, in accordance with embodiments.

The method disclosed by FIG. 2 may include using 2-gram matches from a method consistent with FIG. 1 and a calculation of semantic similarities.

At step 205, the text or call processing program of FIG. 1 or a separate instance of a text or call processing program, may receive utterances unlabeled by the method of FIG. 1 and that have 2-gram matches from the method of FIG. 1.

At step 210, the text or call processing program may compare each unlabeled production, uᵢ, to one or more seed productions “uₚᵢ.” The text or call processing program may collect a seed training “Uₜ^{I}” and its intent I. The seed training may include phrases relevant to the intent I.

At step 215, the text or call processing program may place a user utterance and a seed utterance in an embedded space.

At step 220, the text or call processing program may use one or more distance measures. The similarity between two utterances (e.g., the user utterance and the seed production) may be measured in the embedded space. As an example, the text or call processing program may, for each distance measure DISTₘ, m Σ {word embedding method, cosine similarity measure method, cross-coder method}, compute a set of distances Dₚᵢ^{DIST m} from uₚᵢ to each seed train utterance uₜ^{I} of Uₜ^{I}.

The word embedding method may compute a first distance using an unsupervised word embedding method. The text or call processing program may measure a dissimilarity between two text documents as the minimum amount of distance that the embedded words of one document need to ‘travel’ to reach the embedded words of another document. The method for embedding may use a machine learning model that can be trained based on seed utterances and/or past user utterances. The input to the word embedding method may be a pair of utterances (e.g., “check my balance” and “I want to get my recent transactions). Intermediate embeddings that include values that represent a position of each of utterances may be generated. The position may be based on a vector size, a number of words, a difference of a number of words, or a difference of a number of characters. An output of the word embedding method may be generated based on the intermediate embeddings that represents a distance between the two positions of the words of the input utterances.

The cosine similarity method may compute a second distance using a pretrained network that uses cosine similarity between sentence embeddings. The cosine similarity method may use Siamese and triplet network structures to derive semantically meaningful sentence embeddings. For example, a bi-coder may include splitting a user utterance into two embeddings, u and v. The two embedding may be based on poolings based on masked portions of the user utterance, the poolings and embeddings being processed separately. An input of the cosine similarity method may be a pair of utterances (e.g., “check my balance” and “I want to get my recent transactions). The cosine similarity method may generate intermediate embeddings, u and v as values based on poolings from the pair of utterances that are processed separately. An output of the cosine similarity method may be generated using a cosine function of the intermediate embeddings that outputs a distance between the two input utterances.

The cross-coder method may compute a third distance. A bi-coder of the bi-coder method may include masking portions of the pair of utterances. An input of the cross-coder method may be a pair of utterances (e.g., “check my balance” and “I want to get my recent transactions). The cross-coder method may user a classifier to generate an output indicating a distance between the two input utterances. The output may be between 0 and 1.

At step 230, the text or call processing program may for each distance measure, compute mean mₚᵢ^{DIST m} and standard deviation stdₚᵢ^{DIST m} of Dₚᵢ^{DIST m} and save it for uₚᵢ, by generating a dictionary with (k, v)={uₚᵢ, (mₚᵢ^{DIST m} stdₚᵢ^{DIST m})}.

At step 240, the text or call processing program may execute a scoring model for each production utterance uᵢ with an associated pseudo-label.

At step 250, the text or call processing program may, based on the score from step 240, apply a threshold for each pair and assign the associated pseudo-label as a label based on the threshold. As an example, if an output score>=or exceeds a threshold (e.g., three), the text or call processing program may assign the intent of the matched seed production as the label of uᵢ. The output score may be based on whether each distance (e.g., distance one, two, three) is less than a mean, mₚᵢ^{DIST m} plus standard deviation, stdₚᵢ^{DIsT m} If so, each distance determination may increase by 1. If a 2-gram match is present, the output score may be increased by 1. As an example, if the three distances are less than the mean plus standard deviation and there is a 2-gram match, the output score may be 4, which is above a threshold of three. This output score represents a pass and that the user utterance matches a seed production. As another example, if one distance is less than the mean plus standard deviation and the other two distances are greater than the mean plus standard deviation, respectively, and there is a 2-gram match, then the output score may be 2, which is less than a threshold of three. This output score represents a fail and that the user utterance does not match a seed production.

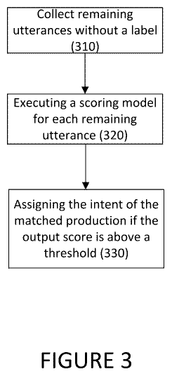

At step 260, the text or call processing program may send the remaining user utterances without a label to a method consistent with FIG. 3.

FIG. 3 illustrates a logical flow for labeling utterances, in accordance with embodiments.

The method disclosed by FIG. 3 may capture user utterances that do not include any important key word or phrase but have a high semantic similarity to a seed utterance.

At step 310, the text or call processing program of FIG. 2 or a separate instance of a text or call processing program, may receive user utterances without labels processed by the method of FIG. 2.

At step 320, the text or call processing program, for each remaining user utterance uᵢ, may execute a scoring model. The scoring model may be similar to step 250 disclosed above. Assuming no 2-gram matches are available, the output score is generated only from a comparison of the three distances to means plus standard deviations, as discussed above. A pass or fail, and the total output score, is thus based only on semantic similarity for step 320.

At step 330, the text or call processing program may, if output score>=a threshold (e.g., three), then assign the intent of the matched seed production as the label of uᵢ. The output score and compared to a threshold, similar to step 250 discussed above.

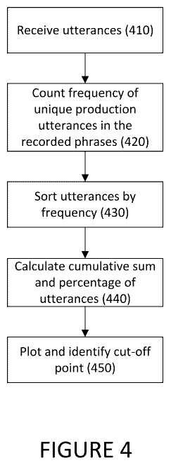

FIG. 4 illustrates a logical flow for labeling utterances, in accordance with embodiments.

The method disclosed by FIG. 4 may estimate an optimal number of seed utterances so that the seed utterances can be used as input into the methods consistent with FIGS. 1-3. In particular, manual labeling of huge numbers of utterances is practically impossible. Thus, determining an optimal number of seed utterances is crucial to balance a need for accurate model training with the constraints of manual labeling.

At step 410, the text or call processing program may receive a total number of utterances, including past user utterances. Past user utterances may be utterances received by users through a text or a call or the like over a period of time such as one or more years.

At step 420, the text or call processing program may count a number of unique utterances from the number of utterances and may further associate the number of unique utterances with a unique utterance. Each utterance may be a phrase or sentence. For example, an utterance may be “I'd like to check my last transaction,” “I want to talk to someone,” or “Let me talk to a loan person.”

At step 430, the text or call processing program may sort the utterances from step 420 in order based on the count. For example, a most frequent utterance may be sorted first and a least frequent utterance last or vice versa.

At step 440, the text or call processing program may progressively calculate a sum of the frequency as a proportion of the cumulative sum of the total number of utterances based on the order. For example, if a number of utterances is four different phrases, W, X, Y, and Z, then cumulate frequency may be as follows: 4637 (total number of utterances)=2377 (number of utterances of W)+1459 (number of utterances of X)+769 (number of utterances of Y)+32 (number of utterances of Z)=4637

Then, the sum of the frequency may be ordered and then calculated as follows:

$$Cum\_Freq of W : ( 2377 , 2377 / 4637 = \sim 51 \% )$$

$$Cum\_Freq of X : ( 1459 + 2377 = 3836 , 3836 / 4637 = \sim 83 \% )$$

$$Cum\_Freq of Y : ( 769 + 3836 = 4605 , 4605 / 4637 = \sim 99 \% )$$

$$Cum\_Freq of Z : ( 32 + 4605 = 4637 , 4637 / 4637 = 100 \% )$$

At step 450, the text or call processing program may generate a plot of a curve of the proportion of the cumulative sum of frequency (cum_freq) of each utterance (Y axis) versus the number of unique utterances (X axis). The text or call processing program may next calculate a beginning of a plateau of the curve. For example, the beginning of the plateau of the curve may be used to determine the number of unique utterances needed as seed utterances. The point of the plateau curve may be calculated based on when a rate of change of the curve begins to slow (if the order of utterance frequency is from large to small) or increase (if the order of utterance frequency is from small to large). For example, the point may be calculated based on when the rate of change begins decreasing or increasing linearly rather than exponentially. The x-axis associated with the point may be the point of the number of utterances to be used.

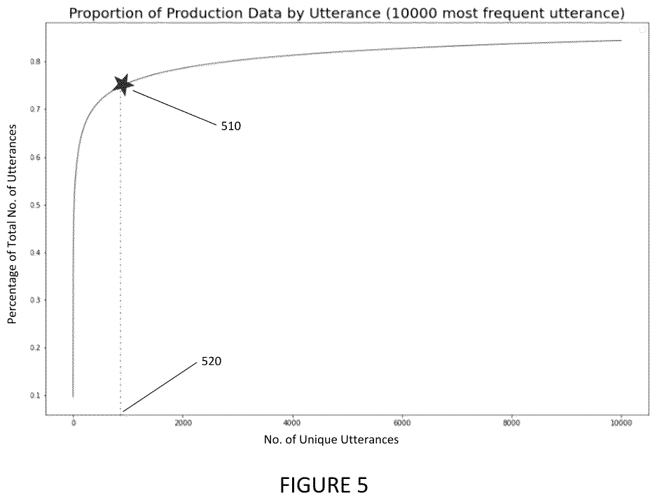

FIG. 5 illustrates a graph of an elbow method used for labeling utterances, in accordance with embodiments.

FIG. 5 illustrates a plot of a curve as discussed above with reference to step 450. The text or call processing program may generate a plot of a curve of the proportion of the cumulative sum of frequency (cum_freq) of each utterance (Y axis) versus the number of unique utterances (X axis). The point 510 may be the point at which the curve plateaus and may be calculated as discussed above. The point 510 may represent the point at which the curve becomes linear instead of exponential. The point 510 may represent the point at which the curve's rate of change is beneath a threshold.

The text or call processing program may determine the x-axis point 520 that aligns with the calculated plateau point 510. The x-axis point 520 may be the number of occurrences necessary for a number of seed utterances.

Although FIG. 5 illustrates one way the curve could be graphed, showing a y-axis with increasing cumulative number of utterances and an x-axis with an increasing number of unique utterances, it is contemplated that similar graphs and calculations could be produced that would achieve the same result. For example, the x-axis and y-axis could be reversed or a decreasing cumulative number of utterances could be graphed.

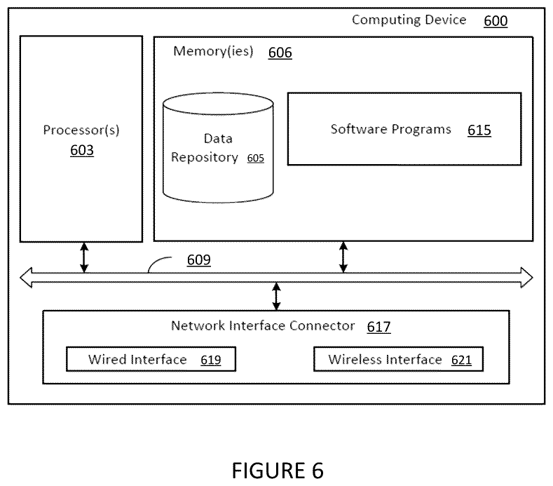

FIG. 6 illustrates a block diagram of a computing device for implementing certain embodiments of the present disclosure. FIG. 6 depicts exemplary computing device 600. Computing device 600 may represent hardware that executes the logic that drives the various system components described herein. For example, system components such as a ML model engine, an interface, various database engines and database servers, and other computer applications and logic may include, and/or execute on, components and configurations like, or similar to, computing device 600.

Computing device 600 includes a processor 603 coupled to a memory 606. Memory 606 may include volatile memory and/or persistent memory. The processor 603 executes computer-executable program code stored in memory 606, such as software programs 615. Software programs 615 may include one or more of the logical steps disclosed herein as a programmatic instruction, which can be executed by processor 603. Memory 606 may also include data repository 605, which may be nonvolatile memory for data persistence. The processor 603 and the memory 606 may be coupled by a bus 609. In some examples, the bus 609 may also be coupled to one or more network interface connectors 617, such as wired network interface 619, and/or wireless network interface 621. Computing device 600 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications, or equivalent arrangements.

1. A method performed by one or more computers, the method comprising:
receiving, by a text or call processing program, a plurality of seed utterances each with a predefined seed label;
receiving, by the text or call processing program, a first user utterance;
converting, by the text or call processing program, the plurality of seed utterances and the first user utterance into n-gram phrases;
grouping n-gram phrases of the plurality of seed utterances into phrase pools based on whether the n-gram phrases are 2-gram phrases or 3-gram phrases;
executing, by the text or call processing program, n-gram matching of the first user utterance with a first seed utterance of the plurality of seed utterances; and
assigning, by the text or call processing program, a first intent label to the first user utterance based on a match of 3-gram phrases with the first seed utterance of the plurality of seed utterances.

2. The method of claim 1 further comprising:
filtering out, by the text or call processing program, non-frequent n-gram phrases in each phrase pool based on a predefined frequency threshold.

3. The method of claim 1 further comprising:
receive, by the text or call processing program, a second user utterance; and
marking, by the text or call processing program, a second user utterance with only one or more 2-gram matches for further processing.

4. The method of claim 3 further comprising:
executing, by the text or call processing program, matching of the second user utterance with a second seed utterance of the plurality of seed utterances based on a pseudo-label of the second user utterance and the predefined seed label of the second seed utterance, the matching comprising:
determining an output score comprising the 2-gram match and a distance between the second user utterance and the second seed utterance; and
determining the output score exceeds a threshold score; and
assigning, by the text or call processing program, the pseudo-label as a second intent label to the second user utterance based on the matching.

5. The method of claim 1 further comprising:
receive, by the text or call processing program, a third user utterance; and
marking, by the text or call processing program, the third user utterance with no n-gram matches for further processing.

6. The method of claim 5 further comprising:
executing, by the text or call processing program, matching of the third user utterance with a third seed utterance of the plurality of seed utterances based on a pseudo-label of the third user utterance and the predefined seed label of the third seed utterance, the matching comprising:
determining an output score comprising at least two distance measures between the third user utterance and the third seed utterance; and
determining the output score exceeds a threshold score; and
assigning, by the text or call processing program, the pseudo-label as a third label to the third user utterance based on the matching.

7. The method of claim 1 further comprising:
determining, by the text or call processing program, a text response or an audible response based on a search of responses associated with the first intent label; and
outputting, by the text or call processing program, the text response or the audible response.

8. A computer processing system comprising:
a memory configured to store instructions; and
a hardware processor operatively coupled to the memory for executing the instructions of a text or call processing program to:
receive a plurality of seed utterances each with a predefined seed label;
receive a first user utterance;
convert the plurality of seed utterances and the first user utterance into n-gram phrases;
group n-gram phrases of the plurality of seed utterances into phrase pools based on whether the n-gram phrases are 2-gram phrases or 3-gram phrases;
execute n-gram matching of the first user utterance with a first seed utterance of the plurality of seed utterances; and
assign a first intent label to the first user utterance based on a match of 3-gram phrases with the first seed utterance of the plurality of seed utterances.

9. The system of claim 8, the instructions further comprising:
filter out, by the text or call processing program, non-frequent n-gram phrases in each phrase pool based on a predefined frequency threshold.

10. The system of claim 8, the instructions further comprising:
receive a second user utterance;
mark the second user utterance with only one or more 2-gram matches for further processing.

11. The system of claim 10, the instructions further comprising:
execute matching of the second user utterance with a second seed utterance of the plurality of seed utterances based on a pseudo-label of the second user utterance and the predefined seed label of the second seed utterance, the matching comprising:
determining an output score comprising the 2-gram match and a distance between the second user utterance and the second seed utterance; and
determining the output score exceeds a threshold score; and
assign the pseudo-label as a second intent label to the second user utterance based on the matching.

12. The system of claim 8, the instructions further comprising:
receive a third user utterance; and
mark the third user utterance with no n-gram matches for further processing.

13. The system of claim 12, the instructions further comprising:
execute matching of the third user utterance with a third seed utterance of the plurality of seed utterances based on a pseudo-label of the third user utterance and the predefined seed label of the third seed utterance, the matching comprising:
determining an output score comprising at least two distance measures between the third user utterance and the third seed utterance; and
determining the output score exceeds a threshold score; and
assign, by the text or call processing program, the pseudo-label as a third label to the third user utterance based on the matching.

14. The system of claim 8, the instructions further comprising:
determining, by the text or call processing program, a text response or an audible response based on a search of responses associated with the first intent label; and
outputting, by the text or call processing program, the text response or the audible response.

15. A non-transitory computer readable storage medium, including instructions stored thereon, which when read and executed by one or more computer processors, cause the one or more computer processors to perform steps comprising:
receiving, by a text or call processing program, a plurality of seed utterances each with a predefined seed label;
receiving, by the text or call processing program, a first user utterance;
converting, by the text or call processing program, the plurality of seed utterances and the first user utterance into n-gram phrases;
grouping n-gram phrases of the plurality of seed utterances into phrase pools based on whether the n-gram phrases are 2-gram phrases or 3-gram phrases;
executing, by the text or call processing program, n-gram matching of the first user utterance with a first seed utterance of the plurality of seed utterances; and
assigning, by the text or call processing program, a first intent label to the first user utterance based on a match of 3-gram phrases with the first seed utterance of the plurality of seed utterances.

16. The non-transitory computer readable storage medium of claim 15 further comprising:
filtering out, by the text or call processing program, non-frequent n-gram phrases in each phrase pool based on a predefined frequency threshold.

17. The non-transitory computer readable storage medium of claim 15 further comprising:
receiving a second user utterance;
marking, by the text or call processing program, the second user utterance with only one or more 2-gram matches for further processing.

18. The non-transitory computer readable storage medium of claim 17 further comprising:
executing, by the text or call processing program, matching of the second user utterance with a second seed utterance of the plurality of seed utterances based on a pseudo-label of the second user utterance and the predefined seed label of the second seed utterance, the matching comprising:
determining an output score comprising the 2-gram match and a distance between the second user utterance and the second seed utterance; and
determining the output score exceeds a threshold score; and
assigning, by the text or call processing program, the pseudo-label as a second intent label to the second user utterance based on the matching.

19. The non-transitory computer readable storage medium of claim 15 further comprising:
receiving, by the text or call processing program, a third user utterance;
marking, by the text or call processing program, the third user utterance with no n-gram matches for further processing;
executing, by the text or call processing program, matching of the third user utterance with a third seed utterance of the plurality of seed utterances based on a pseudo-label of the third user utterance and the predefined seed label of the third seed utterance, the matching comprising:
determining an output score comprising at least two distance measures between the third user utterance and the third seed utterance; and
determining the output score exceeds a threshold score; and
assigning, by the text or call processing program, the pseudo-label as a third label to the third user utterance based on the matching.

20. The non-transitory computer readable storage medium of claim 15 further comprising:
determining, by the text or call processing program, a text response or an audible response based on a search of responses associated with the first intent label; and
outputting, by the text or call processing program, the text response or the audible response.
